(19) United States
(12) Patent Application Publication
(10) Pub. No.: US 2024/0113523 A1
(43) Pub. Date: Apr. 4, 2024

(54) ENERGY STORAGE SYSTEM AND POWER SUPPLY SYSTEM FOR MARINE VESSELS

(71) Applicant: Kongsberg Maritime AS, Kongsberg (NO)

(72) Inventor: Rune VAN RAVENS, Slattum (NO)

(73) Assignee: Kongsberg Maritime AS, Kongsberg (NO)

(21) Appl. No.: 17/769,154

(22) PCT Filed: Oct. 26, 2020
(86) PCT No.: PCT/EP2020/079995

§ 371 Date: Apr. 14, 2022

(30) Foreign Application Priority Data
Oct. 25, 2019 (NO) 20191280

(51) Int. Cl. H02J 3/32; B63H 21/17; H02J 3/00; H02J 3/04; H02J 3/46

(52) U.S. Cl. CPC H02J 3/322; B63H 21/17; H02J 3/0073; H02J 3/04; H02J 3/46; H02J 2310/42

(57) ABSTRACT

Energy storage system suitable for retrofitting into a power supply system as well as method and power allocation system related to this. The power supply system comprises at least two segregated power system sections, each constituting a redundancy group, each comprising an AC switch board and at least one of a power generator adapted to generate an electrical power to the switch board and/or power consumer drawing power from said switchboard. The energy storage system is configured to be coupled to the AC switch board in each of the at least two redundancy groups, the unit constituting a common and autonomous energy storage system, the energy storage system including an energy management system adapted to distribute additional power between the energy storage system and redundancy groups, and/or between the redundancy groups through the energy storage system, thus providing an additional segregated power source.

The present invention relates to retrofitting a energy storage system for a power supply system comprising at least two redundancy groups, as well as a corresponding energy storage and power allocation system and method for allocating power, especially for use in marine vessels.

A large number of vessels, new builds and candidates for retrofit, are being designed to be hybrid to reduce operational costs (fuel and maintenance) and emissions. Hybrid vessels typically reduce fuel consumption and operational costs by operating with fewer engines, more optimally. Hybrid solutions are introduced for redundancy and to limit the number of additional engines that must be on-line and ready to compensate for undesirable load fluctuations of engines and/or propulsion units. Of course, additional on-line engines, decreases the engine utilization and efficiency. Several such systems are described in WO2016/150815 and EP3035477

Retrofitting energy storage systems on vessels equipped with redundant power supply systems, e.g. dynamically positioned vessels add a number of new problems to the implementation.

Vessels with redundancy requirements as dynamically positioned vessels, have historically been designed and constructed with an electrical system consisting of two or more redundancy groups. The redundancy is essential for marine operations where a vessel must be able to maintain positing after loss of one redundancy group. These redundancy groups, for which each power system is typically equipped with power generation, electrical switchgear and drives for propulsion units, where typically designed for segregated operation. Segregated operation was the safest means to ensure that a fault in one redundancy group, or electrical system, would not propagate to others.

In recent years, aiming to reduced operational costs and emissions, more and more new builds have been designed and operated for operating with electrically interconnected redundancy groups. Closing the interconnecting bustie breakers between each redundancy group or systems is commonly referred to as “closed bustie” or “closed ring” operation. Operating all redundancy groups as one optimized power plant provides multiple benefits in particular for the operation of diesel engines. For example, all engines share loads fluctuations and there is no uneven load distribution. In case of a fault, the remaining engine power can be optimally distributed and utilized. Generally, the flexible power plant utilization allows for running fewer engines where each engine operates at a higher utilization. Consequently savings fuel, emissions and maintenance.

Regulatory bodies, classification societies, vendors, and constellations of vessel operators and vessel charterers have worked to develop methods and conditions for how to design and test the systems of vessels in order to allow for safe operations with closed bustie as described in US00908317762. Despite the efforts and reduced risk, there is still a risk of incidents, partly due to mistakes in initial design or modifications, or in faulty operation (human error) of the systems. Some charterers and operators of vessels are still reluctant to allow closed busties in critical operations requiring redundancy. Furthermore, the majority of vessel in operation were not designed for closed bustie operations at time of construction. The cost and time to upgrade and test all equipment and systems of a vessel in order to get final approval for closed bustie operations may prove too high. Hence, the majority of vessels may continue to operate with segregated power systems at the cost of higher fuel and emissions.

A similar trend in the maritime industry to reducing fuel and emissions has been to install energy storage units. A energy storage units, whether the storage media is a flywheel, batteries or high power capacitors, typically serve to complement the use of conventional combustion engines. For vessels requiring redundancy in design, the energy storage serves two primary purposes.

Firstly, the energy storage may serve as “spinning reserve”, meaning that the stored energy may serve to provide power to the systems' consumers in case of a failure. This rather than having surplus engine capacity in the form of running engines ready to take on the addition load in case of one system failing. E.g. batteries would constitute a chemical energy reserve replacing combustion engines for “spinning” reserve. With stored energy serving as spinning reserve, each engine may be loaded higher before requiring start of additional engines. On average fewer engines will be required running, increasing efficiency of each engine which again reduces emissions and cost of fuel and maintenance.

Secondly, the energy storage may provide “peak shaving” capacity. Power consumption on a vessel will vary with operations and environment. E.g. both propulsion units keeping vessels in position as well as the operational process equipment will cause power to fluctuate. Unlike for combustion engine, storage energy from e.g. batteries, can provide power almost instantly. This allow faster ramp up of process- and propulsion equipment, but more importantly offload the mechanical stress on engines. High power fluctuations traditionally implied more engines to handle the load changes. When complimented by energy storage, the same power fluctuating may achieved with fewer engines (avoiding start-up of additional engines). So with fewer engines running and increased efficiency of each engine, one would reduce emissions and cost of fuel and maintenance.

Energy storage systems are often economically viable for new-build vessels where the energy storage systems may be incorporated into the power and propulsion plant design. The introduction of energy storage systems may serve to reduce the total installed power to overweight and even reduce the overall Costs.

When energy storage systems are considered for retrofit, the typical challenge is the high costs of batteries and the space, weight as well as the time without income during the upgrade and installation work. Consequently, the key to reduced emissions by retrofitted energy storage systems is to reduce the overall costs and time of the upgrade.

Prior art shows various approaches to retrofitting energy storage systems into vessels designed with redundancy.

The most common approach has been to install one energy storage systems for each of redundancy groups of the vessel. This is a safe and conservative approach. What is considered optimal will vary from vessel to vessel, however, this approach's disadvantage is typically the high cost, space, weight and impact of the modification. To illustrate, for a vessel with two redundancy groups, a fault one of the redundancy groups, e.g. short circuit of main switchboard, would also cause loss of one of the two connect energy storage systems. So twice as much battery capacity is required compared to a solution which would not lose any energy storage capacity at the same time as losing a main redundancy group. Additional breakers in the existing switchgear would be installed to connect each energy storage system to the electrical distribution system. Secondly, multiple energy storage systems would often require multiple battery rooms which again adds to the impact of the upgrade in terms of space, weight and time.

A more complex approach has been to upgrading the entire existing power plant to be capable of operating with closed busties. Thereby one may add a new switchboard section to which an energy storage systems in connected. If correctly design, approved and operated, such upgraded power and prolusion plants may get the same benefit from a single autonomous, central energy storage system supporting. So no energy storage capacity would be lost at the same time as losing a main redundancy group. This allow to eliminate surplus capacity of energy storage system and thereby reduce space, weight and cost.

However, this would typically require careful review of the existing vessel and typically complex upgrades of: the electrical system (switchgear, protection relays, voltage regulation); electrical drives; system studies; Power Management System; DP consequence analyzer; UPS, ventilation; cooling systems and potentially also fire and flooding segregations.

Further, for operations where Owner or vessel charterer require the vessel to be operated with segregated, open busties, such central energy storage system can only be connected to and support one of the redundancy groups. So both emission reductions and pay-back time is uncertain and conditional on being operating with closed busties. As a result, the cost, risk and complexity of such upgrades have stopped many such upgrades from being implementation.

A third approach could be to consider connecting a central energy storage system to the DC-bus of two drives where these drives belong to two different redundancy groups. This may be drives for thrusters, drilling, winches etc. Such solution is described in EP3035477. Assuming correct design and operation, a shared energy storage system could partially support two redundancy groups. However, this solution must be based on active front end drives. The vast majority of vessels have drives utilizing diode rectifiers between the main switchboard and the DC link of the drive, so power can only flow to the drive, but not from the drive back to the main grid. Such energy storage system would have very limited peak shaving capability. Further, in the event of a failure of the engines of a main redundancy group, the energy storage system would not provide the key function of temporary bridging av power outage until main power can be restored or operations safely terminated. With loss of main power, all the power to all auxiliaries would be lost. Hence if the energy storage system is connected to the DC-link of two thruster drives, the lack of auxiliary power would cause all engines and thrusters of the redundancy group to be disconnected despite theoretically having partial power to drive the thruster's propulsion motor.

As noted above, the majority of vessels is not suitable for retrofitting solutions as described in EP3035477 as is it would not be considered autonomous and fault tolerant for the electrical system. The same level of fault tolerance must similarly be ensured and documented for other auxiliary systems as control power (UPS), cooling systems etc.

The power of such energy storage system is limited and dedicated to the connected thrusters and cannot be freely allocated by the vessel's Dynamic Positioning system. Consequently, the power is most likely not approved as “spinning reserve” by classification society. With the limitations to both peak shaving and spinning reserve, this approach has shown marginal interest and potential.

A traditional based hybrid system has typically been added as a Energy Storage System (ESS) package and the control method has been droop control on the Energy Management System (EMS) towards the ESS package. This control method may lead to several challenges when it comes to how to prioritize the flow of power from generator's and battery, since the common link is the frequency and voltage. Controlling the flow of energy based only on frequency and voltage will typical limit flexibility in the ESS utilization, and lead to sub-optimal operation.

If a fixed regime decides when to stop and when to deliver power from battery or generators, there will be some limitations in the system. Typically, in an electric power plant there will be a consumer load control system which will reduce/limit and distribute power to the different heavy consumers. If the battery EMS has no information about different consumers limits or the prioritization between them, there may typically be some hidden power reserves which will not be used, since the consumer limits have to be set before the reduction system. If the limits are known as well as the availability of the reserves for your thrusters when the reduction system reduces some of the consumers, a smaller installed battery is required to handle these challenges.

Thus additional objects of the present invention are
Retrofitting energy storage systems connected to multiple redundancy (two or more) groups, but with minimum impact (cost, space, weight and off-hire time) to the existing vessels. Specifically, the invention is designed to enable installed in one location (e.g. and fire and flooding zone), typically in a container on deck or, if space allows, integrated into the vessel hull.
Additional benefits of going hybrid, the invention offer similar benefits as if operating with closed bus-ties even for vessels which are not designed or approved for operating with closed bus-ties. However, this is achieved without going through a complex upgrade with time and cost and of assessing and upgrading all the existing utility systems and documentation required to obtain approval by classification society to operate with closed bus-ties.
Be independent of daily changes to the configuration of the power and prolusion system, or operational mode (with operator intervention). Specifically, the bus-tie connecting the main redundancy groups may be open and closed without any action to the ESS. This is contrary to ESS systems requiring assignment switching for various configurations of the power and prolusion system. Hence, the invention reduces operational processes and the risk of human error of operators.

It is an object of the present invention to solve or limit several of the limitations of prior art for energy storage system being retrofitted into vessels operating with split busties which constitutes the vast majority of existing DP vessels. The object is obtained as specified in the accompanying claims.

The present invention provides this by using a common autonomous energy storage medium capable of distributing power to a number of redundancy groups which can be implemented in existing vessels.

The present solution also improves the robustness of the power plant. This as the Energy Storage System (ESS) may compensate possible uneven load distribution of the two or more main redundancy groups even when the bus-ties between these main switchboards are open. Hence, enabling transfer of power from one group to another without closing the bus-ties of the main switchboards. The present invention also provides the possibility to operate with the main switchboard open, but with the advantages as a closed bus system when it comes to spare capacity from the on-line generators and the flow of energy between electrical segments.

The present invention also provides benefits over other implemented system benefits similar to combining both multiple conventional energy storage system as well as operation with closed busties—even for vessels not designed and approved for closed ring operations, such as
Transfer power from one group to another in case of loss of engine power, e.g. preventing partial black-out by bridging a temporary power outage until another engine is brought online.
One single battery (the largest and most costly part of an ESS system) may serve multiple redundancy groups through the ESS with AC connections to the switch boards of the redundancy boards.
Fault tolerant design, so no battery capacity is lost in case of failure of a main redundancy group. Consequently, battery capacity is reduced (container/space, weight, cost)
only one location and battery room reducing complexity, cost, time and weight of the retrofit.
Unlike prior art solutions, the invention may be interconnected between bustie cables of two redundancy groups and thereby reuse both bustie cable and breakers on sub-distribution board level. This would reduce the required modification of existing equipment since additional breakers are not required. Power may still be transferred between redundancy group through the ESS, and the retrofitted ESS may be connected at the switchgear closest to the intended battery room location to minimize cable modifications.
Utilizes spare capacity of the existing A and B cooling systems, similarly to conventional ESS retrofits with dedicated ESS per existing system. The 2×100% (A+B) cooling systems constitute a redundant feeding into the new closed loop chillers and coolers of the new system (C).
If the invention is connected to more than two redundancy groups, the system only need supply from two of the existing fresh water cooling systems.
Optimal control and allocation of power among multiple redundancy groups even when operating with open bus-ties

The present invention will be described below with reference to the accompanying drawings, illustrating the invention by way of examples.

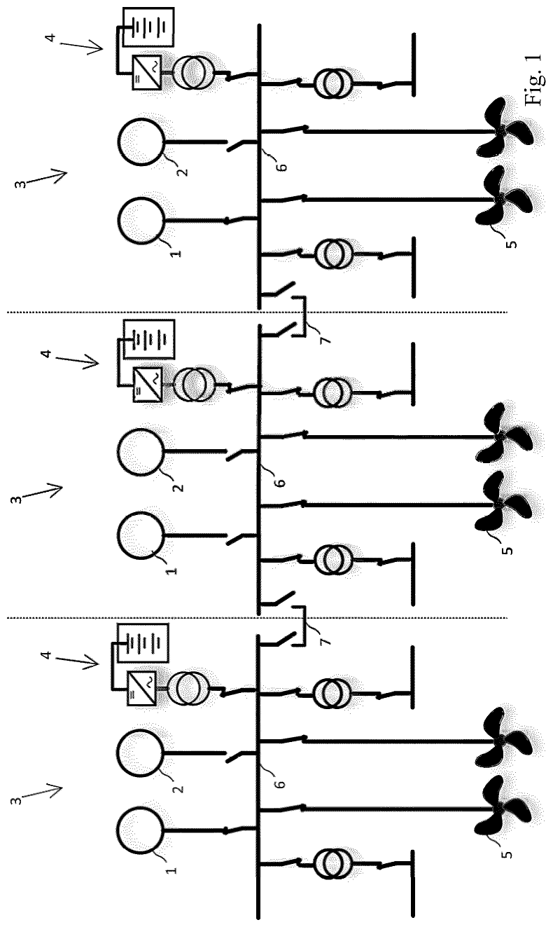

FIG. 1 illustrates the known art.

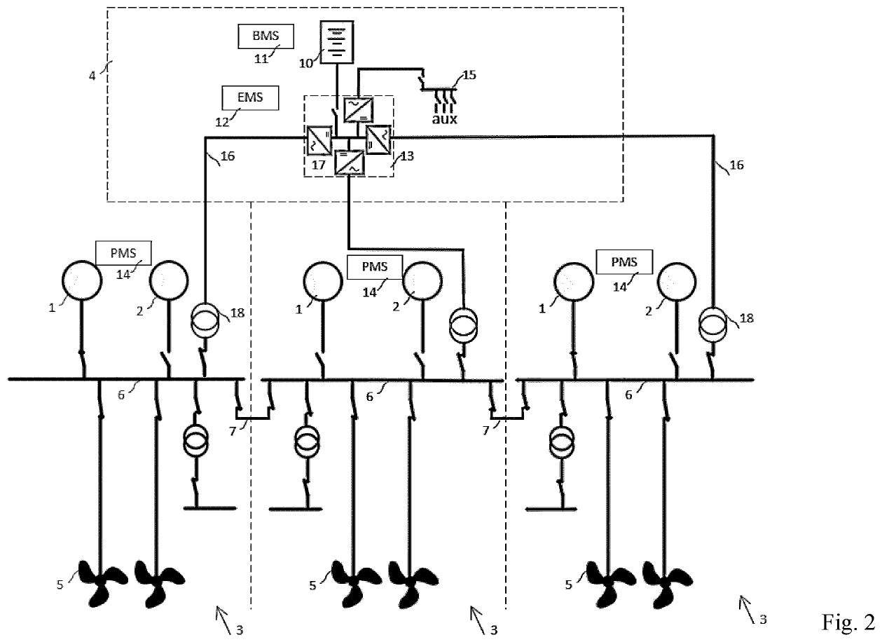

FIG. 2 illustrates an embodiment of the invention with three redundancy groups.

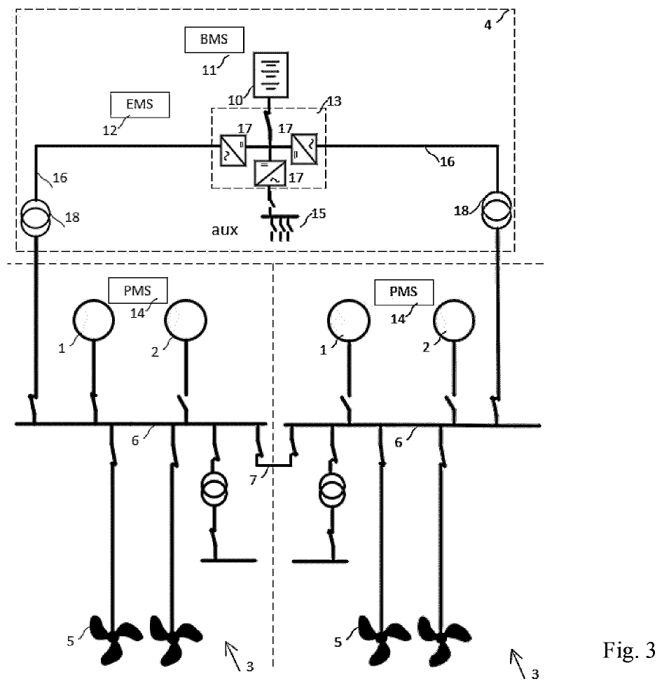

FIG. 3 illustrates an embodiment of the invention with two redundancy groups.

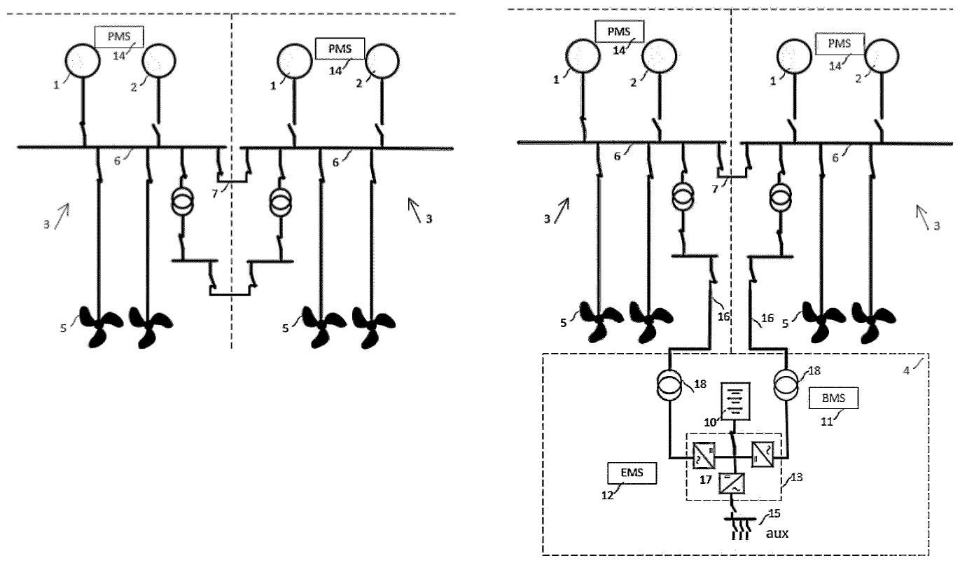

FIG. 4 illustrates the retrofitting of the energy storage system according to the invention into an existing system.

As can be seen from FIG. 1 the systems according to the known art are constituted by a number of redundancy groups 3, each including at least one generator 1. In the illustrated example there are two generators 1,2 where one is active 1 and the second 2 in the illustrated example is not activated but may be started if the primary generator 1 stops or has reduced capacity. In addition, at least two of the redundancy groups may include an energy storage system (ESS) 4 capable of reducing load fluctuations and handling interim periods, e.g. providing power while the secondary generator is started.

The redundancy groups 3 also include power consumers 5 such as motors as pasts of the propulsion system of a vessel. In the drawings the consumer is simply illustrated as a propeller.

As illustrated the redundancy groups have separate switch boards 6 connecting the units in each group, but may be provided with switches or bus-ties 7 between the groups provided with protection as is well known in the art to avoid errors propagating though the system. The fault protection system if intended to operate with closed busties is per se e.g. as described in EP2654157, and will not be discussed in detail here. However, as previously noted, the majority of operating vessels considered to be upgraded with energy storage are not designed and approved for operating with closed busties.

Since after a failure in the system as illustrated in FIG. 1, one ESS unit 4 will also be lost, each ESS will require higher combined rating (kWh) than if loss of ESS would not have occurred (n−1<n). With more energy installed (kWh), the cost, space, weight of the equipment is consequently increased. Minimizing space and weight of equipment is an important target for most new build vessels. In case of retrofit, the increased equipment, space and modification work further result in more time off-hire.

The illustrated embodiment of the invention according to FIGS. 2 and 3 includes an ESS including a battery management system (BMS) 11 coupled to an energy management system (EMS) 12 controlling energy distribution to a number of redundancy groups through an ESS converter type distribution board 13, hereafter called ESS distribution board, where each redundancy group have a power management system (PMS) 14 capable of controlling the generators and consumers in the redundancy group and for reporting and requesting additional power from the EMS.

The ESS distribution board 13 preferably a DC system being connected to the AC switch boards 6 of the redundancy groups 3 though a DC/AC converter in the ESS and an AC connection to the redundancy group switch boards 6.

Optionally the AC connection between the ESS and each redundancy group will include a suitable transformer as well as protection devices in the redundancy groups. In FIG. 2 the transformer 18 is positioned in the redundancy group but in FIG. 3 it is located in the ESS. The preferred location of a retrofitted transformer would depend on available space on the vessel, if the solutions is supplied in a container and so forth.

The retrofitting is illustrated in FIG. 4 where a system according to prior art is shown on the left, including two bus-ties 7 between two redundancy groups 3. On the right the ESS 4 is connected over one of the bus-ties through connections 16. This is a fairly simply operation and also makes it possible to keep the complete ESS in a separate redundancy group. The ESS group may be autonomous providing power to an auxiliary switchboard coupled to pumps, UPS etc.

The autonomy of all auxiliary systems includes dedicated converter to power to auxiliaries of the ESS redundancy group through the dedicated auxiliary switchboard 15, or potentially achieved by duplicating power and consumers by feeding from two main redundancy groups/switchboards.

Placing the PowerAllocator in the link of an existing bustie, e.g. in the ESS to avoid extending and modifying existing switchgear provides another advantage with the present invention.

The system may thus, though the AC connections between the ESS and the redundancy groups, both supply power to a redundancy group from the energy storage and channel power to the energy storage or auxiliary equipment. The system also includes wired or wireless communication system not shown in the drawings for reporting the status of the key components in the system enabling the system or an operator to distribute power according to reported needs. The chosen communication system may depend on the implementation in the original system as well as the retrofitting operation.

In detail the EMS may be considered to consist of two layers, a top level EMS and an Energy Control System (ECS).

The EMS defines settings of the power and propulsion plant for each operational modes of the vessel, e.g. required quantity of engines, thresholds for starting and stopping engines etc.

The Energy management system thus includes an energy control system (ECS) where all the flow of energy are controlled. The ECS system are integrated with the EMS where modes of operation and cost function of how to run the most optimized way are selected and communicated to the ECS layer. The ECS layer can typically be duplicated based on amount of multi-drives or switchboard segments. EMS will get info from the Battery Management system (BMS) to be able to control the battery in a safe and efficient way. The EMS system will typically be interfaced to a maneuvering system/DP system to get the optimal allocation of power on the thruster/propulsion units, which again will give basis to optimize the flow of power between the multi-drive units.

Optimal thruster allocation and optimal load sharing is typically achieved with closed bus operation where the flow of power between segments and generators is free and unrestricted. Further energy is to be transferred with minimal power losses.

To fulfill the class rules for marine vessels with DP2/DP3 notation, faults in one redundancy group are required to be isolated, hence not propagate to any other redundancy group. Therefore, the safest and easiest way to keep the redundancy group separated regarding common faults are to operate with the bus-tie breaker open to separate the redundancy groups.

However, interconnecting the redundancy groups by closing bus-ties on main switchboard imply several challenges:
1. Maximum number of engines online may be restricted due to short circuit level. Hence, some changes to the configuration of the electrical system may be required to change to split mode operation.
2. An advanced electrical protection scheme must be applied to ensure that a fault on one redundancy group does not propagate to another redundancy group. This may be complex and costly, and even more challenging for upgrade after initial installation.
3. An advanced control protection scheme must be applied for protection against engine control failure. AC power plant system which consist of 2 or more generators connected, will always have some challenges when they are operated in parallel. Either on the same switchboard segment or one engine on each switchboard segment connected. Since an AC system will have a common frequency between the connected generators, the load-sharing will be affected by a fault on either speed controller or voltage controller on the system. To handle this type of faults a protection system can be installed, either closing down the faulty engine, or by operating the switchboard segments in split configuration to remove the possibility of a common fault like this totally.

In terms of control, the batteries safety features in the illustrated example are controlled by the Battery Management System (BMS) 11. The control and utilization of energy between engines and ESS, and allocation between redundancy groups may be controlled by the Energy Management System (EMS).

The ESS distribution board may also be capable of powering the system's auxiliary systems as UPS, cooling etc in order to make the ESS system fully autonomous, as well as be used to feed thruster drives directly from the same DC bus the ESS is connected to. The power to auxiliaries are locally fed from the system's dedicated auxiliary switchboard 15.

The ESS distribution board in FIG. 2 distributes the power through individual DC/AC and DC/DC converters to the redundancy groups and auxiliaries and will preferably also include protection circuits for avoiding propagation of errors in case of a fault condition through the switchboard and protection units between the redundancy groups.

This way the present invention will avoid losing ESS at the same time as loosing engines (a redundancy group), which will enable limiting the installed capacity of each ESS and also unnecessary many battery rooms. Thus, the present invention provides a reduction in cost, space, weight and time for installation and modification of the units.

The ESS solution is thus designed to be autonomous of the other redundancy groups, hence constituting an additional redundancy group with stored energy.

As mentioned above the ESS is linked to the remaining redundancy groups with fault tolerant AC connections, hence a fault in a main redundancy group would not cause the redundancy group with the ESS to fail. This is achieved by installing appropriate and per se known protections and ensuring full redundancy in design.

In order to be considered to contribute to the redundancy of the system, the energy available to the respective main redundancy groups has to be monitored and controlled. Energy controlled and allocation may be linked to the positioning or navigation control system—ensuring optimal energy allocation to other components in a vessel as described in the abovementioned WO2015/028621.

If integrated with a dynamic positioning (DP) system the consequence and analysis of the DP system may calculate the remaining time a battery can deliver power based on the current system status and weather conditions. Normally this calculation is done by the State of Charge (SoC) and the State of Health (SoH) of the battery, but with severe limitations since information about expected consumption is in general unknown. To be able to calculate an improved estimate of the correct remaining time the forces needed for the thrusters and the required hotel load etc provided by the DP system analysis may be used. Both information about the losses in the system as well as the consumed power needed to be supplied from the battery is utilized. This is preferable if the battery power should be counted into the capability of the vessel, which is typically referred to as battery power notation by the class.

For precise calculations the DP consequence and capability analysis is informed about the correct power consumption on thrusters and other service loads including all distribution losses. When the DP consequence analysis calculate the remaining power available after a loss of a generator or a thruster, the correct power from all the different auxiliaries, which also may be removed to obtained the correct remaining power on the system.

All this is again critical to be able to calculate the correct remaining time on the battery to be able to indicate a correct required time to safely terminate the ongoing operations, often referred to as Time To Terminate (TTT). If these calculations are correct it is possible to set up the EMS a little bit different since it will be known how far down the battery can be run and still have enough energy left to TTT.

This and other data such as power requirements, consumption, energy generation etc about the system and the included components will be known and used by the energy management system, and in addition the components, redundancy groups and sections may be monitored by sensors etc in order to improve the performance of the system.

For vessels requiring redundancy in the power and propulsion plant, the machinery utilization is limited to be able to compensate for loss of one redundancy group (lost power and propulsion). Generally, ESS may be considered contribution to the redundancy (loss of engine power) through the energy it can provide for the duration required to safely terminate the vessels operations. As the ESS can increase power available for remaining propulsion units, fewer engines may be required online.

Thus, the ESS power available for the respective redundancy groups must be monitored and communicated. During power shortage where the ESS provide power to multiple redundancy groups, the EMS will allocate power where it can be best utilized for the purpose of the vessel (most efficient propulsion or positioning). For dynamically positioned (DP) vessels, the EMS will interface the DP system for the DP Consequence Analysis to calculate optimal allocation. This may increase the uptime of the vessel and/or reduce the required number of engines online.

Eliminating loss of ESS at the same time as engines, would typically reduce the required installed capacity of each ESS. This may be a significant cost saver for the ESS related equipment. Less equipment implies less space and weight, which again is further improved if eliminating need for several battery rooms.

As stated above the present invention has been described with relation to a specific example. There are, however, known alternatives within the field, where the chosen solution may depend on the circumstances.

As an example the main power source or generator 1,2 will usually be diesel engines in a diesel-electric system providing power to the main switch boards. Depending on the available fuel gas turbines, gas engines and fuel cells may be used. The energy storage system may be based on commercially available batteries, but fly wheels, ultra/super capacitors etc may also be contemplate. The safety control system for any energy medium is hereafter generically referred to as Battery Management System (BMS).

As stated above the ESS will usually include a protection unit (not shown), e.g. circuit breaker or power electronics type load breaker in series with fuse and/or contactor, and a second order protection may be provided as a fuse at ESS transformer secondary winding or two circuit breakers or fuses in series. The protection means are chosen so as to both protect the energy storage but also the redundancy groups connected to each other through the ESS and the ESS distribution board 13.

In addition, as shown in the drawings, commercially available converters may be chosen in the system depending on the different units and system requirements, such as AC/AC, AC/DC, DC/DC, respective IGBT, IGCT, Diode etc.

In FIGS. 2 and 3 the battery 10 is coupled to the grid through the ESS distribution board 13 and a number of DC/AC converters 17 to the individual redundancy group switch boards 6, through a transformer 18. This may also be performed in a number of different ways, also depending on each redundancy group if they are different. Examples showing such variations of how/where to connect an ESS in a grid, may include through a DC/DC converter to a DC grid, through a DC/AC-converter and transformer, directly through a DC/AC-converter to an AC-grid, through a DC/AC-converter to a local AC switchboard of a drive, e.g. Including local auxiliary consumers, directly connected to a DC grid drive or connected to a DC-link in a multidrive.

The implementation of the present invention may involve the following:
The single container, or the system within a zone (if integrated into the vessel hull) is design as self-contained/autonomous for all auxiliary system.
DC distribution board 13 for battery connection.
Electrically, the cable connections to the main redundancy groups are protected by dual barrier protection acc. relevant classification society rules.
The system according to the invention is kept electrically self-contained with auxiliary power. A dedicated inverter feeds a local dedicated distribution board 15. Hence normally the auxiliary equipment may draw power from the main redundancy groups through the DC link and inverter, or alternatively from battery in case of loss of engine power.
The power control for the ESS 4 may be designed self-contained by UPS fed directly from DC link of the ESS hub 13 or from the dedicated auxiliary board (15)
Unlike prior art solutions, the invention may be interconnected along the bustie cables of two redundancy groups and thereby reuse both bustie cable and breakers on sub-distribution board level. This would reduce the required modification of existing equipment since additional breakers and switchgear modifications are not required. The intended back-up function for power transferred between redundancy group is ensured though the ESS. This further allows the retrofitted ESS to be connected to the switchgear closest to the intended battery room location to minimize cable modifications.
The invention may be extended with a flexible solution for shore connection where frequency converters may compensate for varying frequency and voltage available at various ports.
The Energy Management System/control system is dedicated and communicating with dual, fail-safe communication to the PMS and DP systems (particular rules may follow class notation.
With less engines running, spare capacity of two of existing cooling systems is utilized to feed the container or zone of the invention. The piping is equipped with fast closing values and monitoring to ensure segregation and avoiding propagation of fault in case of leakage. Piping only required from two redundancy groups in case of powering three or more redundancy groups. The system may additionally fed HVAC unless containerized where designed for air-air heat exchanger.
Dedicated fire detection and fighting system for the container (or zone)
Dedicated battery management system, gas detection and ventilation system to non-hazardous area according to relevant class rules.

The majority of maritime vessels are designed to run onboard engines to power the vessel when laying at wharf. The vessels shore connection is usually limited in capacity to transfer power, if installed at all.

For smaller vessels to draw power from the land based mains supply when docked is not a new phenomenon. Shore power has been used extensively for many years for vessels with moderate power requirements; typically less than 50 to 100 kW. These vessels are capable of making use of normal grid voltage and frequency, and replace the energy from the generators with the shore power with only marginal investments. For the larger vessels with higher power requirements (100 kW up to MW-range) it gets a bit more complicated. To serve these vessels with shore power, dedicated and relatively costly installations are required, both on land and on board the vessels. This may include upgrading the grid capacity, frequency converters and complex high power connectors. Consequently, relatively few vessels and ports are capable of making use of shore power, even though the environmental upsides are considerable. The cost of upgrading vessels with shore connection enabling zero emissions and noise can be a complex effort with high costs. This in part as voltages for shore connection may vary from port to port (400/440/690V/6600/11000 V) and frequency of vessels are usual 60 Hz as opposed to many ports providing 50 Hz. Nevertheless, an increasing amount of national or regional authorities demand vessels to reduce emissions when vessels are at port or berth.

The invention may also include a connection circuitry for receiving high power shore connection and convert frequency and voltage according to the main grid voltage of the vessel. This shore connection may be provided at significantly lower cost as the majority of costly components as converters, transformers and cabling are part of the initial energy storage solution. Hence the invention, if extended with high power shore connection, can not only reduce emissions when offshore, but also become zero emission at shore/port.

To summarize the present invention involves retrofitting an energy storage system as an autonomous, new redundancy group 4 for coupling to a power supply system comprising at least two segregated power system sections, each constituting a redundancy group 3, each comprising at least one of a power generator adapted to generate an electrical power to a switch board and a power consumer, such as a propulsion unit, drawing power from said switch board.

According to the invention a switch board in the at least two redundancy groups are coupled to a common energy storage system, the energy storage system including an energy management system adapted to distribute power between the energy storage system and redundancy groups, and/or between the redundancy groups through the energy storage system, e.g. if one redundancy groups has available power while another groups has a power failure. Thus providing an additional segregated power source. This way the system provides a common energy storage and control system with an energy storage system distribution board allowing to distribute power between the segregated sections, and in this way reduces the need for extra power storage such as batteries in each segregated section. Energy is preferably controlled to flow both ways (not diode), and may also direct transfer from one switchboard to another without power entering the battery.

The energy storage system (ESS) distribution board can be used to share load between the redundancy groups even if the main switchboard is operated with an open bus or is segregated. The power distribution allows power to travel both ways and be based on the optimal allocation between engines or to and from battery. This way the typical challenges as described earlier are removed with the common link frequency and voltage between redundancy groups/sections by controlling the distribution based on directing power between the sections.

The energy storage system may include converters for actively controlling the consumers and generators and the power distribution between the redundancy groups in the system, e.g. based on information about the elements in each groups and monitored information such as power generation, consumption and status of each component.

The energy storage system distribution board preferably also includes protection units between the connected segregated power system sections.

The energy management system utilizes power allocation system for use in a power supply system including at least two segregated power system sections thus constituting two redundancy groups, each redundancy group comprising at least one of a power generator and a power consumer being connected through a switch board. As mentioned above the power allocation system includes at least one energy storage and a energy management unit connected to the energy storage, the energy management system being coupled to each of the segregated power system sections, switch boards and adapted to at a power fluctuations in said redundancy group supply power from said battery to the ESS distribution board. Thus at the detection of undesirable power fluctuations or power outages in a redundancy group, supply power may be directed from the battery to the switchboard or vice versa. Further, power may also be transferred from a heathy redundancy group to one with power outage of high fluctuations, hence providing power capacity beyond the energy and power of the battery. The power consumption and generation in each group or section may be monitored by suitable sensors and may also include known data related to each component in the sections, such as minimum power requirement, lifetime variations and limitations.

The ESS distribution board includes protection units between the connected segregated power system sections and the ESS includes an AC auxiliary switchboard suitable for connecting to auxiliary equipment such as pumps, thus facilitating powering of the auxiliary equipment from any one of the power generators and/or energy storage.

The power allocation may also involve load sharing by controlling a power flow between generators over the ESS distribution board, and the power may be supplied to said segregated power sections based on predetermined information about the consumers and generators in the section. This way the method for power optimal allocation of the flow of energy is performed either between segments by allowing load sharing of generators over the ESS distribution board or by supplying directly from battery to achieve the optimal allocation of load on the generators on each segment, based on type of engine, fuel, engine dynamics or engine response on load variations. As is shown in the drawings the power allocation system may be connected over an existing bustie between the redundancy groups, for example implemented in an energy storage system, thus allowing easy installation into existing systems.

The invention also involves a method for allocating power to a segregated power supply system sections for marine vessels, where at least two segregated power system section thus constituting two redundancy groups comprising at least one of a power generator and a power consumer being connected through a switch board, the system also comprising a power allocating system including a energy storage system and being connected to each redundancy group switch boards. The method includes the steps of monitoring the power availability in of each redundancy groups and at a detected power fluctuation in a group allocating power to or from said segregated power system section.

1-13. (canceled)

14. A power allocation system suitable for retrofitting into a power supply system comprising at least two segregated power system sections constituting two redundancy groups, each of the two redundancy groups defining a segregated section comprising at least one of a power generator and a power consumer connected through an AC switch board, the power allocation system comprising:
at least one energy storage system and an energy management unit connected to the energy storage system comprising an energy storage system distribution board;
wherein the energy management system is coupled to each of the segregated power system sections switch boards through an AC connection and adapted to at detected power fluctuations in the redundancy group supply power to or from the battery through the energy storage system distribution board;
wherein each of the two redundancy groups comprises sensors monitoring the power consumption and generation of each groups and the energy storage; and
a communication system for receiving the information from the sensors, the energy management unit distributing power based on the information from the sensors.

15. The power allocation system according to claim 14, wherein the energy storage system distribution board comprises protection units between the connected segregated power system sections.

16. The power allocation system according to claim 15, being adapted to be connected over an existing bustie between the two redundancy groups.

17. A method for allocating power to a segregated power supply system sections for vessels comprising at least two segregated power system sections constituting at least two redundancy groups comprising at least one of a power generator and a power consumer being connected through an AC switch board, the segregated power supply system comprising a power allocating system comprising a energy storage system and being connected to each redundancy group switch boards though an AC connection, the method comprising:
monitoring the power consumption and generation in of each redundancy groups and at a detected power fluctuation in a group; and
allocating power to or from the segregated power system section based on the monitored consumption and generation.

18. The method according to claim 17, comprising load sharing by controlling a power flow between generators over the ESS switchboard.

19. The method according to claim 17, supplying power to the segregated power sections based on predetermined information about the consumers and generators in the section.

20. A power allocation system for retrofitting into a power supply system comprising at least two segregated power system sections constituting two redundancy groups, each of the two redundancy groups defining a segregated section comprising at least one of a power generator and a power consumer being connected through aa AC switch board, the power allocation system comprising:
at least one energy storage and an energy management unit connected to the energy storage system comprising an energy storage system distribution board,
wherein the energy management system is coupled to each of the segregated power system sections switch boards through an AC connection and adapted to at detected power fluctuations in the redundancy group supply power to or from the battery through the energy storage system distribution board; and
input for receiving information from each segregated section through a chosen communication system, comprising information related to power consumption and generation in each segregated section, the energy management unit calculating the required distribution of power in the sections.
